(19) United States
(12) Patent Application Publication
(10) Pub. No.: US 2018/0019847 A1
(43) Pub. Date: Jan. 18, 2018

(54) INTEGER PROTOCOL FOR EMBEDDED DEVICES IPED

(71) Applicant: Arnold Peter Ruymgaart, San Marcos, TX (US)

(72) Inventor: Arnold Peter Ruymgaart, San Marcos, TX (US)

(21) Appl. No.: 15/208,884

(22) Filed: Jul. 13, 2016

(51) Int. Cl. H04L 5/00; H04L 29/08; H04L 12/24

(52) U.S. Cl. CPC H04L 5/0044; H04L 41/12; H04L 67/12

(57) ABSTRACT

Presented herein is a communication protocol defining a process of communication (data exchange) between devices. This process consists of organizing a sequence of content fields separated by a separator marker in a meaningful way with the purpose of defining an inter-machine language. The use of a single data type in the protocol along with message uniformity results in the simplest conceptual way of transmitting machine states while meeting all objectives [multiple routing options, etc.]. This means a single computational method of minimal complexity can process all messages. The order of the (meaning of the) leading fields is always the same regardless of the type of message. This further facilitates simple processing: read/write or broadcast messages are all processed the same way. The method favors simplicity and robustness making it ideal for devices with limited state vectors such as sensors and actuators. The use of text or alphanumeric fields like Base64 may be used in lieu of integers. The protocol may be encrypted. The randomness of message length, a result of using separators rather that fixed-width fields aids security by preventing certain encryption attacks. It is more difficult to decipher meaning of random length messages. The use of numbers means a subset of characters are excluded on text-based media. This increases robustness as any message containing other characters may be marked invalid. The protocol is capable of transmitting all of any finite machine state including text and images. The preferred choice of integers as field data type does not prevent transmission of floating point values or other data such as text/image or sound files since each of these can be represented by sequences of (integer) numbers. A distinct advantage is that all states are treated the same way regardless of the type of the original data to be transmitted. The protocol of is self-sufficient; it does not require any underlying functionality of its carrier transmission media besides collision resistance. The messages contain all necessary information for routing, target(s), function, sorting and action to be taken. Accordingly, the protocol supports a wide variety of transmission media. The protocol can be transmitted acoustically where a certain frequency represents a number or optically where a light color represents a number. The protocol can be transmitted without modification on any text based media such as SMS, email or Twitter. A transition from wired to a wireless or other media and vice versa can be made without modification. The routing fields allow unicast (one to one), multi-cast (one to multiple) and broadcast (one to all) type of messages. The protocol can therefore be used to support a variety of network topologies including AdHoc (mesh), etc. Most other protocols with similar functionality include fields of different data types or have different message types (structure) for different functions. Its closest relative is probably the Modbus ASCII protocol. Modbus ASCII is comprised of a string of Hexadecimal integers without separators—thus requiring fixed field length. Modbus ASCII does not provide the means for out-of-order processing (queuing/buffering), broadcast or multicast while requiring more complex implementation since query messages are different from replies precluding a single method of processing.

### FIELD OF THE INVENTION

The invention can be classified in the field of machine communication.

The present invention relates to embedded device (Internet of things) communication and in particular to methods of communicating within networks of devices and client terminals via a standardized protocol.

The invention is specifically aimed at (but not limited to) devices with limited computational and memory resources. Examples include sensors and actuators. The state of operation of these devices is defined by a system state vector of binary and other numeric values. This vector, or elements of it, is accessed by other devices on the network for control and monitoring purposes. The protocol of the present invention provides a means of achieving this. The implementation requires minimal or almost no overhead unless optional encryption and/or mesh routing ability is added. Computational/memory overhead is an important consideration on most devices. The protocol of the present invention allows for complex device network functionality and complete access to the state vector.

### BACKGROUND OF THE INVENTION

Communication between machines is not new. Communications between relatively simple field devices connected by multi-drop serial line to a Master computer in the industrial environment was standardized by the Modbus protocol introduced by Modicon in 1979. Modbus was very well suited for communication on 2-wire type of serial lines. However, it lacks peer to peer and broadcast messaging ability because the message originator is not identified in the message and the Modbus serial line version does not include a transaction ID. This limitation means the messages must be received exactly in order and requires a master-slave (query-response) system. Order of message arrival is not easy to control in Ethernet/WIFI networks. This is one of the reasons Modbus is not well suited for such networks. Another limitation in Modbus is that the frame order is not preserved: e.g. a response message has no ID frame at all. This generates the need for different handling code to parse queries vs responses. The latter significantly complicates computational complexity of the Modbus protocol implementation.

Recent Protocols—Prior Art.

There have been other protocols developed since that overcome some of these limitations. Examples include Message Queuing Telemetry Transport (MQTT) developed at IBM, Extensible Messaging and Presence Protocol (XMPP) developed by the Jabber community and Advanced Message Queuing Protocol (AMQP) developed by JPMorgan Chase for business device messaging.

Features and Limitations in Prior Art

Found lacking in the numerous newer protocols was the Modbus-like simplicity. Besides simplicity of implementation, Modbus-ASCII provided one of the only humanreadable and text transmissible protocols. Most recent alternatives require parsing binary fields generally making them impossible to transmit through text-based media without modification.

Industry Trends

Recent hardware advances have produced a new era of fast wireless communication options between devices. In addition, high-level programming languages such as LUA and Python are now available on very minimal devices. Importantly the latter made available quick methods of sending strings via the (wireless) network without concern about data collisions. Available in all high level languages are simple methods for string to number conversion.

Device State Vector.

Devices can be completely described by a state vector. A simple input toggle switch has a state vector of rank one, just one single binary element. Since computer (and micro controller) based devices exist in a discrete finite state space, all state values are readily represented as integers. This includes analogue values which are of resolution the number of bits of the AD converter. Raw input/output of DA/AD converters is in integer format: as an example, 16 bit AD converter allows for 2¹⁶ positions (possible states) represented by a single integer value ranging from 0 to 65535. A vector of integers represents the total state of the entire device.

### OBJECTS OF THE INVENTION

An objective of this invention is to provide a communication protocol aimed at connecting devices that can be transmitted without translation on text-based media. The protocol should therefore contain no mixture of binary and non-binary fields. Transmission media include any text-based such as SMS-TEXT, email, etc. The protocol should be human readable when not encrypted.

The protocol should be self-sufficient: it should not require functionality of the underlying media to accomplish its goals other than basic transmission and collision avoidance. There should be seamless transition between different kinds of transmission media (such as wired Ethernet to Wifi or Blue tooth or even acoustic).

The protocol must allow native access to the entire state vector of the device.

The protocol should be very simple to implement (as little as a few lines of code). Emphasis should be on minimal complexity and maximal readability by both humans and machines. The decrypted or unencrypted implementation should require very little resources facilitating use on resource limited devices. The simplicity of implementation should also facilitate easy development of software interacting with the device. For example, it should be possible to make a smart-phone or tablet App that controls an IPED device in just a few hours.

The protocol must allow out-of-order processing which in turn allows message queuing and buffering.

Point to point (or peer-to-peer uni-cast), multi-cast (one to several), broadcast (one to all) and query-response transaction types must all be allowed without change in message format. This requirement means the protocol must inherently support Ad Hoc/Mesh networking.

An optional simple data integrity check can be provided depending on media transmission type. Messages other than broadcasts should get a response or receipt.

The protocol must be encrypt-able where secure transactions are required.

The protocol must support addressing a very large number of devices without sub-netting.

The protocol must facilitate device auto-discovery and health monitoring.

All messages should have the same format (structure) regardless of type, function and routing.

### SUMMARY OF THE INVENTION

The present invention provides a method (protocol) of communication between (embedded) devices. The protocol consists of a finite sequence of content fields separated by a separator character “:” like “1:0:3:55:1:6:1:1:” or equivalently “JANE:NONE:JOE:MSG-FIFTY-FIVE:REQUEST-READ:TUPLES:ONE:ONE”. The leading numbers define message routing and functionality while the rest carry data. In a preferred embodiment, integer fields are used with the present invention. These fields are human readable and can be transmitted on any media including text-only social media such as TWITTER, SMS, email, etc. IPED can also be transmitted through wired serial lines or acoustically or optically and can transition between different types of media. IPED is specifically designed for communication with/between devices that have limited memory and computational resources. Decoding and encoding the protocol requires only minimal computational complexity: string to number conversion (built-in all programming languages), parsing the fields and optionally accumulating a checksum. The protocol is self sufficient: besides data, its messages may contain needed information for device routing and targeting as well as message functionality. The protocol supports a variety of network topologies including Ad-hoc/Mesh by providing uni-cast, multi-cast and broadcast targeting.

Additional objects and advantages of the invention will be set forth in part in the description which follows, and in part will be obvious from the description, or may be learned by practice of the invention. The objects and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF THE DRAWINGS

For a more complete understanding of the invention, reference is made to the following description and accompanying drawings, in which:

FIG. 1 Table of ACTION and MTYPE codes. There are generally four message action codes used: 0 broadcast, 1 read, 2 write and 3 reply. Additional action codes may be user defined but the first 10 codes (0-9) are reserved;

FIG. 2 Message Minimal Encode/Decode Functions in Python. This figure exemplifies the simplicity of minimal protocol implementation. Message encode and decoding functions are shown requiring only 5 and 7 lines of code respectively;

FIG. 3 A python function for processing incoming IPED messages is shown. Received message strings are decoded and processed here. A minimal implementation of the protocol does not require recognition of all possible function codes; and

FIG. 4 A device is expected to broadcast two things: (1) a heartbeat message at regular interval and (2) relevant devices states upon any significant change in those states. The Python functions shown generate these messages. The heartbeat function is called by a device timer every time interval. The state change function is called when a significant state change occurs.

### DETAILED DESCRIPTION OF THE PREFERRED EMBODIMENTS

Detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a representative basis for teaching one skilled in the art to variously employ the present invention in virtually any appropriately detailed method, structure or system. Further, the terms and phrases used herein are not intended to be limiting, but rather to provide an understandable description of the invention.

Protocol Format and Description: In one embodiment the protocol of the present invention consists of a string of number fields of the same type separated by a single choice of separator field. In a preferred embodiment, the integer data type is used in the number fields. Another preferred embodiment reserves the leading 7 fields for protocol functionality. In this embodiment the leading six fields are used to define message routing and function. The seventh field contains the number of data fields to follow. All remaining fields are data except the last (optional) field which may contain a checksum.

OID:MSK:TID:TRID:ACTION:MTYPE:ND:[DAT:]_{ND}CHK: (1)

Specifically, the first three fields identify (1) OID [originator device ID] (2) MSK [group mask or topic field] and (3) TID [target device ID (zero in broadcast)] in order to facilitate message routing. Each device has a unique identifying non-zero ID number. Each device sets its own ID in the originator OID field. Unicast (point to point) messaging is then achieved by setting a unique target device ID number in the target TID field. Broadcast (one to all) is achieved by setting the target TID field to zero and multi-cast is achieved by a non-zero MSK field and a zero value in the target TID field. The following three fields are reserved for message functionality. The TRID transaction ID identifies a message with a unique number. This allows a reply or receipt message response to be received in any order by referencing the same TRID. This feature enables the use of queuing/buffering of messages with out of order processing. The ACTION field is used to designate read, write, broadcast or reply (or other general function). The MTYPE field describes the type of data in the payload section and how the data sequence should be interpreted. The ND fields contains the number of data fields DAT that follow up until the optional CHK checksum field.

Transmission of States:

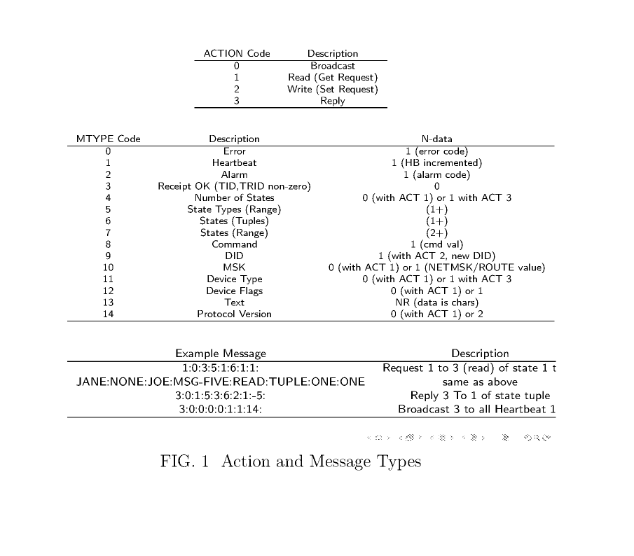

An aspect of the IPED protocol of the present invention is that it is designed to easily transmit the state vector of the device as well as command/health information. The protocol allows transmission of the entire state of a device, often in just one message. This is accomplished by reading or writing state tuples or ranges corresponding to MTYPE codes 6 [tuples] or 7 [range]; see FIG. 1. All accessible device states are organized sequentially. A hash table can be kept for physical memory locations. If there are 4 states, the state reference numbers are 1 to 4 starting at 1, not zero. The state vector of all sub-states represents the device current position in state space. A tuple is the pair (s,v) where s is the state number and v is the value. If the ACTION field is read (1), the data fields contain the start and end of the range requested (2 fields in DAT with ND=2 and MTYPE 7) in case a range request or the sequence of tuple states requested. In an ACTION 3 reply to the read range with MTYPE 7, the first two data fields repeat back the range while the rest contain the values and ND is the number of states in the range plus two.

Use of Field Separation.

Use of a separation character allows variable field size. Besides ease of parsing, this allows relatively efficient transmission of small number values, for example 0 or 1. When using a field separator character, a field does not need a standard frame size. In contrast, without a separator field, any number always requires the same number of characters. For example, in Modbus ASCII a zero field is “0000” and one “0001”. So in IPED small values take up less space despite the added separator. Of course, in any protocol including IPED, multiple bit states may be combined into a single integer even more efficiently into one integer value at the cost of processing speed (message coding/decoding) and readability. With IPED, unless the number of binary states is very large, the preferred method is that analogue and digital states are treated exactly the same way. This means not packing more than one binary value in one integer field, further simplifying implementation.

Protocol Mode of Operation

Each network entity (device or client) is required to have a unique ID. Any message begins with the ID of the originator (OID). Any entity on the network should be able to hear all messages but will only regard them if TID equals the entity ID or zero and the MSK variable matches if a MSK is non-zero. Recipient of a message requiring a response should not respond at all unless TID of the query matches the OID and the MSK value is correct. If these are correct, device may respond error message if an error occurs. Any device is allowed to broadcast or initiate a message.

Device Auto-discovery and Health Devices are required to broadcast an incrementing heartbeat at a regular interval. This heartbeat facilitates auto-discovery functionality is facilitated by simply listening for new heartbeats. Heartbeat broadcast messages allow a listener to check for an “irregular heartbeat”. Irregular heartbeats may be caused by too much CPU load, etc. A heartbeat that does not increment indicates a device reset. If a heartbeat is received too often (and with two different increments) there may be a device ID conflict. State values are expected to be broadcast (only) upon change in state. A change in digital input could be an HMI switch input or a motion sensor detecting motion. A regular device heartbeat without state change message implies no state change has occurred. On other devices on the network that are more sophisticated (have many resources), detailed analysis of device transmission can produce exact status of health. An example heartbeat message without checksum: 1:0:0:0:0:1:1:15:. This message is just 16 bytes long and sends a heartbeat broadcast message from device ID 1 with heartbeat value 15.

Device Commands.

The command message code (8) allows request of device action without the need to send data. For example, message type 8 with value 1 in the single data field may mean “turn on the AC” for an HVAC control device from a client. This is simpler than sending bit or integer registers.

Event Driven Message Functionality.

IPED allows design of an event-driven system as it does not require a query-response (master-slave device) set up. IPED allows Broadcast, multicast (1:many) and unicast peer to peer (1:1) messaging. This means that (sensor) devices are expected to transmit state vector data only when their state changes eliminating the need for polling.

Transmission Media.

IPED It expects the transmission media (physical layer) to be collision resistant and lower layers (e.g. Ethernet) to deal with collisions for full functionality. Serial and Ethernet lines typically incorporate “cleared to send” CTS lines. On non-traditional media collision resistance such as acoustic or optical media a method must be incorporated that checks if the media is busy (a signal is already being sent).

Negotiation

Functionality that falls outside transmission of device states can be negotiated.

Simplicity and Minimal Implementation.

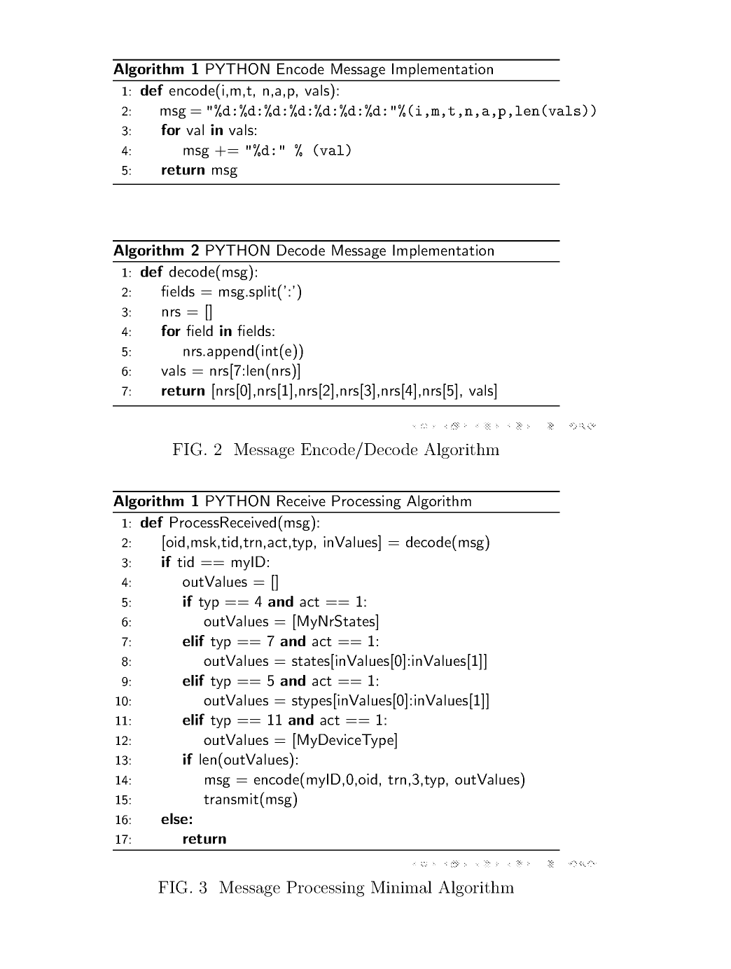

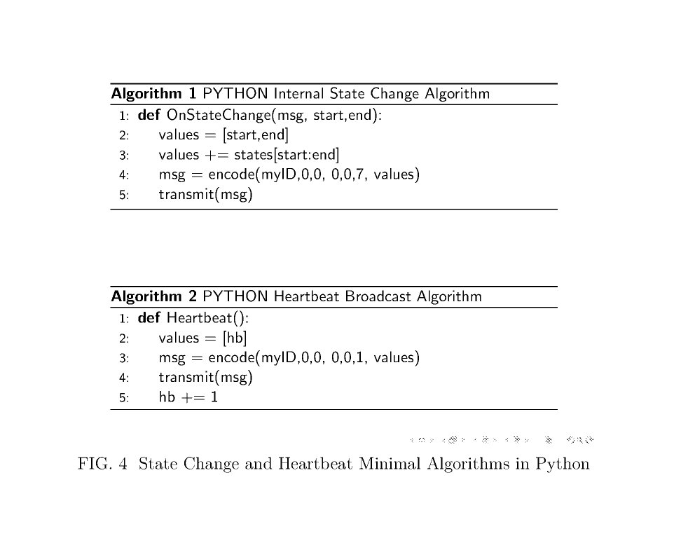

Not all functionality offered by the protocol needs to be implemented. For example, a sensor device need not process any write (action 2) messages. A minimum implementation for a sensor device is shown in FIGS. 2,3 and 4. Only message types 4, 5, 7 and 11 are implemented for reads. Message types 1 and 7 are implemented for broadcasts.

While the foregoing written description enables one of ordinary skill to make and use what is considered presently to be the best mode thereof, those of ordinary skill will understand and appreciate the existence of variations, combinations, and equivalents of the specific embodiment, method, and examples herein. The disclosure should therefore not be limited by the above described embodiments, methods, and examples, but by all embodiments and methods within the scope and spirit of the disclosure.

What is claimed:

1. A method enabling communication between a plurality of interconnected devices comprising:
defining a sequence of content fields, each field of the same data type and separated by a separator field; and
said content fields arranged to provide a plurality of leading fields comprising message functionality and message routing followed by one or more data payload fields.

2. The protocol of claim 1 wherein said separator does not equal any digit/character used in said content fields. Said separator field may be a single reserved character not part of a content field.

3. The protocol of claim 1 wherein content fields are integer numbers or any other data type.

4. The protocol of claim 1 wherein each field is processed by the same algorithm.

5. The protocol of claim 1 wherein said leading fields and data payload fields are processed by the same algorithm.

6. The protocol of claim 1 wherein said leading fields are always processed in the same order by the same algorithm before the data payload fields are processed.

7. The protocol of claim 1 wherein said leading number fields include three routing fields, said three fields configured to identify the origin of said message and a possible subgroup and one or more targets.

8. The protocol of claim 1 wherein said three leading message fields allow unicast, multicast and broadcast messaging.

9. The protocol of claim 1 wherein said leading fields include fields 1-3, field 4 and fields 5-6 where fields 5-6 are configured to provide message function.

10. The protocol of claim 1 wherein field 4 is a transaction ID for the message, said transaction ID enables said system to perform buffering, queuing and out of order processing.

11. The protocol of claim 1 wherein field 5 represents an action to be performed by a target audience. Said actions include reply to read or process write of any device state.

12. The protocol of claim 1 wherein fields 5 and 6 are configured to control or monitor (read or write) the entire state of a device.

13. The protocol of claim 1 wherein fields 5 and 6 are configured to provide the ability of a device to broadcast a heartbeat message to allow auto-discovery of the device and to perform health monitoring.

14. The protocol of claim 1 wherein a device is configured to ignore all but a minimum set of message action and function combinations. The result is an extremely simple and lean minimal implementation. A python example for a sensor device is shown in algorithms 1-5 displayed in FIGS. 2,3 and 4.
